(19) United States
(12) Patent Application Publication
(10) Pub. No.: US 2005/0086471 A1
(43) Pub. Date: Apr. 21, 2005

(54) Removable information storage device that includes a master encryption key and encryption keys

(76) Inventor: Andrew M. Spencer, Eagl, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/689,157

(22) Filed: Oct. 20, 2003

(51) Int. Cl. H04L 9/00

(52) U.S. Cl. 713/165

(57) ABSTRACT

A removable information storage device which encrypts and decrypts encryption keys and data is disclosed. In one embodiment, the information storage device includes a non-volatile memory that is configured to store a master encryption key and includes a non-volatile magnetic memory that is configured to store encryption keys that have been encrypted using the master encryption key and to store data that has been encrypted using the encryption keys.

### BACKGROUND OF THE INVENTION

Personal Data Assistants (PDAs) and cellular phones are designed to act as organizers, note takers and communication devices. PDAs and cellular phones have user interfaces such as touch screens or miniature keyboards which are used to input and store information considered to be private. Cellular telephones are typically used to store confidential information such as address and telephone numbers. PDAs are also used to store address and telephone numbers and can be used to store other business proprietary information such as financial plans, customer lists or product pricing strategies.

Memory cards are becoming available which insert into plug-in expansion slots located on the PDAs or cellular phones. These cards are often times used to store the confidential information, and can be used to store other information such as software for applications, content data for travel software, games or copyrighted digital music. It is desirable to protect the information stored on the memory cards in order to prevent unauthorized access.

To safeguard this information, manufacturers have used embedded EEPROM or flash memory on the memory cards to provide secure storage because their contents cannot be viewed and they are virtually impossible to probe internally. EEPROM and flash memory can be more expensive to manufacture than other types of memory storage devices which do not provide secure storage, and can increase the cost of the memory cards.

Manufacturers have also used encryption algorithms to encrypt confidential information which is stored in non-secure memory which is located on the memory cards. With this approach, the encryption keys used to encrypt and decrypt the confidential information are stored in secure memory such as embedded EEPROM or flash memory which is also located on the memory cards. Because the amount of EEPROM or flash memory storage space required to store the encryption keys can be significant, this approach also can increase the cost of the memory cards.

### SUMMARY OF THE INVENTION

The present invention provides a removable information storage device suitable for use with a host, that encrypts and decrypts encryption keys and data. One embodiment of the present invention provides a removable information storage device which includes a non-volatile memory which is configured to store a master encryption key. The information storage device includes a non-volatile magnetic memory that is configured to store encryption keys that have been encrypted using the master encryption key and to store data that has been encrypted using the encryption keys.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a diagram illustrating one exemplary embodiment of an information storage device according to the present invention.

FIG. 2 is a diagram illustrating one exemplary embodiment of a magnetic memory according to the present invention.

FIGS. 3A and 3B are diagrams illustrating parallel and anti-parallel magnetization of a magnetic memory cell.

FIG. 4 is a diagram illustrating a magnetic memory cell that has been selected during a write operation.

FIG. 5 is a side view illustrating one exemplary embodiment of an atomic resolution storage (ARS) memory used in an information storage device according to the present invention.

FIG. 6 is a simplified schematic diagram illustrating one exemplary embodiment of storing information in the atomic resolution storage memory illustrated in FIG. 5.

FIG. 7 is a top view illustrating one exemplary embodiment of an atomic resolution storage memory which is taken along line 7-7 of FIG. 5.

FIG. 8 is a diagram illustrating one exemplary embodiment of electron emitters reading from storage areas of the atomic resolution storage memory of FIG. 6.

FIG. 9 is a diagram illustrating another exemplary embodiment of electron emitters reading from storage areas of an atomic resolution storage memory.

FIG. 10 is a diagram illustrating a first exemplary embodiment of memory allocation.

FIG. 11 is a diagram illustrating a second exemplary embodiment of memory allocation.

FIG. 12 is a flowchart illustrating an exemplary embodiment of a method of encrypting encryption keys using a master encryption key in an information storage device.

FIG. 13 is a flowchart illustrating an exemplary embodiment of a method of decrypting encryption keys in an information storage device.

### DETAILED DESCRIPTION

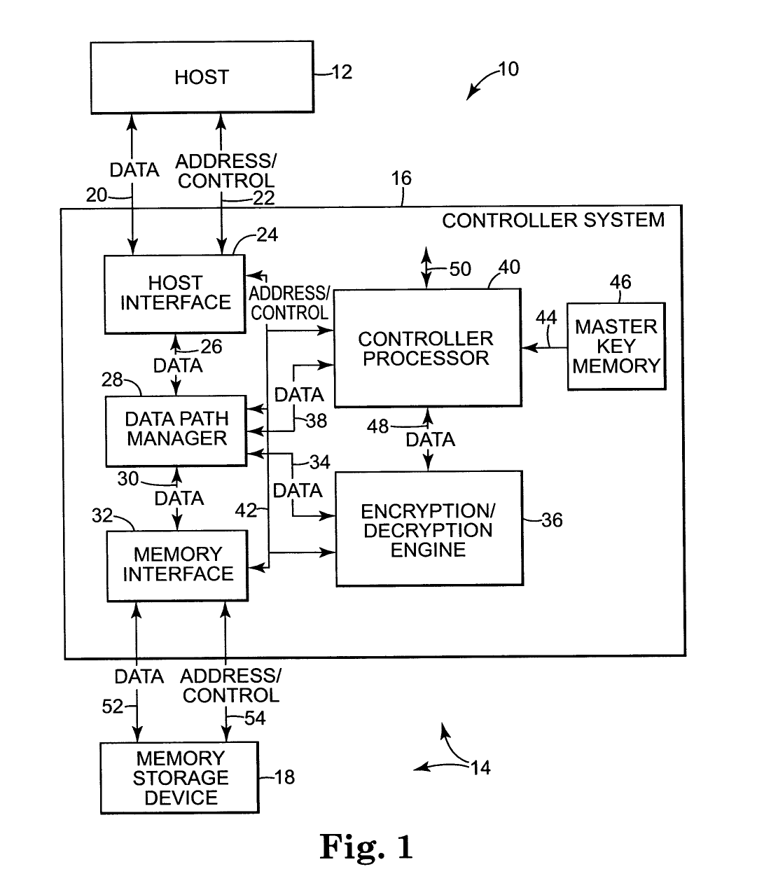

FIG. 1 is a diagram illustrating one exemplary embodiment of an information storage device 14 according to the present invention. In the exemplary embodiment illustrated at 10, information storage device 14 is connected to a host computer 12. In one embodiment, information storage device 14 is small and compact in size. In the illustrated embodiment, the host 12 is a computing device containing a processor and related support electronics such as general purpose computer. In other embodiments, the host 12 can be a Personal Digital Assistant (PDA), a cellular telephone, or any suitable device that requests stored information. In other embodiments, the host 12 and the storage device 14 can be contained within the same physical packaging. In one embodiment, the storage device 14 is located within the host 12. In the illustrated embodiment, the host 12 includes suitable interface circuitry which supports a memory card interface communication standard used by host 12 and information storage device 14. In one embodiment, the memory card interface standard conforms to the Secure Digital standard. In other embodiments, the memory card interface standard conforms to other suitable standards which include, but are not limited to, the CompactFlash® or MultiMediaCard™ standards.

In the illustrated embodiment, the information storage device 14 includes a controller system 16 and a memory storage device 18. Although a single memory storage device 18 is illustrated in FIG. 1, in other embodiments, there can be two or more memory storage devices 18. Information or data is transferred between the host 12 and memory storage device 18 via the controller system 16. In the illustrated embodiment, controller system 16 includes a host interface 24, a data path manager 28, a memory interface 32, a controller processor 40, an encryption and decryption engine 36 and a master key memory 46.

The host interface 24 is configured to provide a communication interface between the host 12 and the controller system 16. In one embodiment, the host interface 24 uses the Secure Digital standard to communicate with the host 12. In other embodiments, host interface 24 uses other suitable interface standards to communicate with the host 12 which include, but are not limited to, the CompactFlash® or MultiMediaCard™ standards. In the illustrated embodiment, host interface 24 is coupled to host 12 via a bus illustrated at 20 which includes one or more data lines, and a bus illustrated at 22 which includes one or more address/control lines.

A memory interface 32 is configured to provide a communication interface between the memory storage device 18 and the controller system 16. The memory interface 32 is coupled to the memory storage device 18 via a bus illustrated at 52 which includes one or more data lines 52 and a bus illustrated at 54 which includes one or more address/control lines 54.

Memory storage device 18 is configured to store encryption keys after the encryption keys have been encrypted using a master encryption key. Memory storage device 18 is also configured to store encrypted data which has been encrypted using the encryption keys and data that is not encrypted.

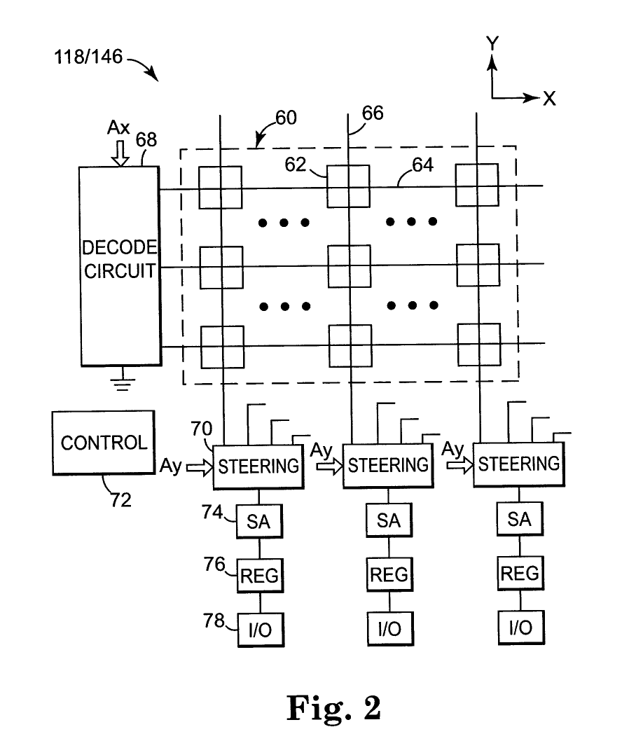

In one embodiment, the memory storage device 18 is a Magnetic Random Access Memory (MRAM) or magnetic memory which is illustrated at 118 in FIGS. 2-4. The magnetic memory provides non-volatile data storage.

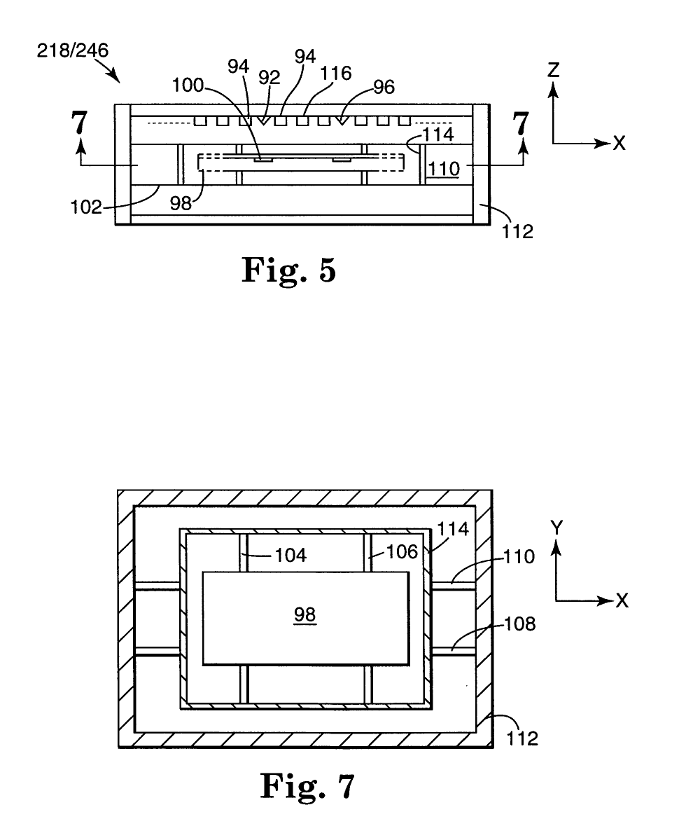

In one embodiment, the memory storage device 18 is an atomic resolution storage (ARS) memory which is illustrated at 218 in FIGS. 5-9. The ARS memory provides non-volatile data storage and is disclosed in U.S. Pat. No. 5,557,596 to Gibson et al., issued Sep. 17, 1996, entitled “Ultra-High Density Storage Device,” which is incorporated herein by reference. In other embodiments, memory storage device 18 can be any other suitable type of non-volatile memory.

In the illustrated embodiment, master key memory 46 is coupled to controller processor 40 via line or lines 44. In various embodiments, master key memory 46 is a non-volatile memory which is configured to store the master encryption key. In one embodiment, master key memory 46 is an MRAM or magnetic memory which is illustrated at 146 in FIGS. 2-4.

In other embodiments, master key memory 46 is a non-volatile, Read-Only memory. In one embodiment, the memory includes fuse elements which operate as storage elements. In one embodiment, the fuse elements are programmed by applying a suitably large current through selected fuse elements to change the resistance of the selected fuse elements. In one embodiment, the resistance is changed from a low value to a high value. In one embodiment, the resistance is changed from a high value to a low value. In one embodiment, the fuse elements are programmed using laser fuse technology to change the resistance of the fuse elements. In various embodiments, the fuse elements function as anti-fuse storage elements.

In other embodiments, master key memory 46 can be other types of Read-Only memory. In one embodiment, master key memory 46 is an Erasable Programmable Read-Only Memory (EPROM). In one embodiment, master key memory 46 is an Electronically Erasable Programmable Read-Only Memory (EEPROM). In one embodiment, master key memory 46 is a Flash Erasable Programmable Read-Only Memory (FEPROM). In one embodiment, master key memory 46 is a One Time Programmable Read-Only Memory (OTPROM). In one embodiment, master key memory 46 is a Nitrided Read-Only Memory (NROM).

In the illustrated embodiment, encryption and decryption engine 36 is coupled to controller processor 40 via data line or lines 48 and is coupled to data path manager 28 via data line or lines 34. Encryption and decryption engine 36 is configured to use encryption algorithms to encrypt and decrypt the encryption keys using the master encryption key. Encryption and decryption engine 36 is also configured to encrypt and decrypt data using one or more of the encryption keys.

In the exemplary embodiment, encryption and decryption engine 36 stores one or more encryption algorithms and uses the algorithms to encrypt the encryption keys using the master key and encrypt data using the encryption keys. Encryption and decryption engine 36 decrypts the encryption keys using the master encryption key and decrypts the data using the encryption keys. In one embodiment, encryption and decryption engine 36 is configured to implement one or more symmetrical encryption algorithms based on the master encryption key and the encryption keys. In various embodiments, encryption and decryption engine 36 can be implemented in hardware or software.

In one embodiment, encryption and decryption engine 36 uses Content Protection for Recordable Media (CPRM) encryption algorithms. CPRM utilizes secret encryption keys which are known only to authorized users. Controller processor 40 controls the execution of the CPRM algorithms per the CPRM specification. CPRM provides copy protection for recordable media and uses Cryptioneria Cipher (C2) with 56-bit encryption keys. CPRM uses a unique encryption key for each device having recorded media. The unique encryption key can be used to prevent copying or to provide an identification process which must be performed before data protected by CPRM can be transferred from the recorded media or memory storage device 18. Encryption and decryption engine 36 is configured to use C2 to encrypt the CPRM encryption keys and the data.

In one embodiment, encryption and decryption engine 36 uses the Data Encryption Standard (DES). DES was developed and promulgated by the National Bureau of Standards. With DES, information is encoded in 64-bit blocks using a single 56-bit key, as described in National Bureau of Standards' Federal Information Processing Standards Publication 46, “Data Encryption Standard,” National Bureau of Standards (1977). In this embodiment, controller processor 40 controls the encryption and decryption of data in accordance with DES. With DES, the data is encoded in 64-bit blocks using a 56-bit key, and encryption keys are encoded in 64-bit blocks using a 56-bit master key.

In other embodiments, encryption and decryption engine 36 uses other suitable encryption standards or algorithms. One approach uses two keys, one for encrypting the data, and one for decrypting the data. This approach is termed a public key system because one set of encryption keys can be made public and are used to encrypt the data stored in memory storage device 18, and another set of encryption keys which are encrypted using the master encryption key are kept secret and are used to decrypt the data. In one embodiment, the public key system is the RSA algorithm, which is named after the inventors Rivest, Shamer, and Adelman. The RSA approach is described in U.S. Pat. No. 4,405,829. In other embodiments, other suitable encryption algorithms can be used.

In the illustrated embodiment, controller processor 40 is coupled to encryption and decryption engine 36 via one or more data lines 48, and is coupled to data path manager 28 via one or more data lines 38. One or more address/control lines 42 are coupled between host interface 24, data path manager 28, memory interface 32, encryption and decryption engine 36 and controller processor 40. Controller processor 40 includes a diagnostic port at 50 which provides a port for running diagnostic tests on information storage device 14. In one embodiment, the master encryption key and encryption keys are written to information storage device 14 via diagnostic port 50.

In the illustrated embodiment, controller processor 40 controls the encryption and decryption of the encryption keys using the master encryption key and controls the encryption and decryption of the data using the encryption keys. In one embodiment, the controller processor 40 is configured to authenticate communication with the host 12 by decrypting one or more of the encryption keys and comparing the encryption keys to a password or other token such as a random number provided by the host 12. Communication is authenticated with the host 12 if the decrypted encryption keys and the password or token have a predetermined relationship. In one embodiment, the predetermined relationship is equivalency on a bit-by-bit basis. In one embodiment, controller processor 40 authenticates communication with host 12 if predetermined data stored in memory storage device 18 has a predetermined state. In various embodiments, the host 12 can authenticate the information storage device 14, or the information storage device 14 can authenticate the host 12.

In the illustrated embodiment, data path manager 28 is coupled to the host interface 24 via one or more data lines 26, and is coupled to the memory interface 32 via one or more data lines 30. Data path manager 28 is coupled to the controller processor 40 via one or more data lines 38, and is coupled to encryption and decryption engine 36 via one or more data lines 34. Data path manager 28 is configured to manage communication of the unencrypted and encrypted data and the unencrypted and encrypted keys, between the host 12, the memory storage device 18, the controller processor 40 and the encryption and decryption engine 36.

In the illustrated embodiment, the encryption keys are encrypted by the encryption and decryption engine 36 using the master encryption key. The master encryption key is read from master key memory 46 by the controller processor 40 and is transferred to encryption and decryption engine 36. The encryption keys are encrypted by encryption and decryption engine 36 using the master encryption key and are stored in memory storage device 18. Encryption and decryption engine 36 transfers the encrypted encryption keys to memory storage device 18 via data path manager 28 and memory interface 32. In one embodiment, the encryption keys are provided to encryption and decryption engine 36 via port 50 on controller processor 40. In one embodiment, the encryption keys are transferred to the encryption and decryption engine 36 from the host 12 via host interface 24, data path manager 28 and controller processor 40. In one embodiment, the encryption keys are read from memory storage device 18 and are transferred to encryption and decryption engine 36 via memory interface 32, data path manager 28 and controller processor 40.

In the illustrated embodiment, the encrypted encryption keys are decrypted by encryption and decryption engine 36 using the master encryption key. The master key is read from master key memory 46 by controller processor 40 and is transferred to encryption and decryption engine 36. The encrypted encryption keys are read from memory storage device 18 and are transferred to encryption and decryption engine 36 via memory interface 32 and data path manager 28. Encryption and decryption engine 36 decrypts the encryption keys using the master key and transfers the decrypted encryption keys to controller processor 40.

In the illustrated embodiment, data is encrypted by encryption and decryption engine 36 using the decrypted encryption keys. The encryption keys are transferred from controller processor 40 to encryption and decryption engine 36. The data is encrypted by encryption and decryption engine 36 and is stored in memory storage device 18. Encryption and decryption engine 36 transfers the encrypted data to memory storage device 18 via data path manager 28 and memory interface 32. In one embodiment, the data is transferred to encryption and decryption engine 36 from host 12 via host interface 24, data path manager 28 and controller processor 40. In one embodiment, the data is read from memory storage device 18 and is transferred to encryption and decryption engine 36 from memory storage device 18 via memory interface 32, data path manager 28 and controller processor 40.

In the illustrated embodiment, the encrypted data is decrypted by encryption and decryption engine 36 using the encryption keys. The encrypted encryption keys are decrypted as described above and are provided by controller processor 40 to encryption and decryption engine 36. The encrypted data is read from memory storage device 18 and is transferred to encryption and decryption engine 36 via memory interface 32 and data path manager 28. Encryption and decryption engine 36 decrypts the data using the encryption keys and provides the decrypted data to controller processor 40. In one embodiment, controller processor 40 provides the data to host 12 via data path manager 28 and host interface 24. In one embodiment, controller processor 40 provides the data to memory storage device 18 via data path manager 28 and memory interface 32, and stores the data in memory storage device 18. In one embodiment, the data includes computer readable instructions which can be executed by controller processor 40.

FIG. 2 is a diagram illustrating exemplary embodiments of a magnetic memory 118 and a magnetic memory 146 according to the present invention. The magnetic memory 118/146 includes an array 60 of magnetic memory cells 62 which are arranged in rows and columns, with the rows extending along an x-direction and the columns extending along a y-direction. Only a relatively small number of magnetic memory cells 62 are shown to simplify the description of the invention. In other embodiments, the array 60 is any suitable size. In other embodiments, the array 60 can utilize highly parallel modes of operation, such as 64-bit wide or 128-bit wide operation.

In one embodiment, word lines 64 extend along the x-direction in a plane on one side of array 60 and bit lines 66 extend along the y-direction in a plane on an adjacent side of array 60. In one embodiment, there is one word line 64 for each row of array 60 and one bit line 66 for each column of array 60. In the embodiment illustrated in FIG. 2, each magnetic memory cell 62 is located at an intersection or cross point of a word line 64 and a bit line 66.

The magnetic memory cells 62 are not limited to any particular type of device. Magnetic memory cells 62 may be, for example, spin dependent tunneling junction devices, anisotropic magnetoresistance devices, giant magnetoresistance devices, colossal magnetoresistance devices, extraordinary magnetoresistance devices or very large magnetoresistance devices.

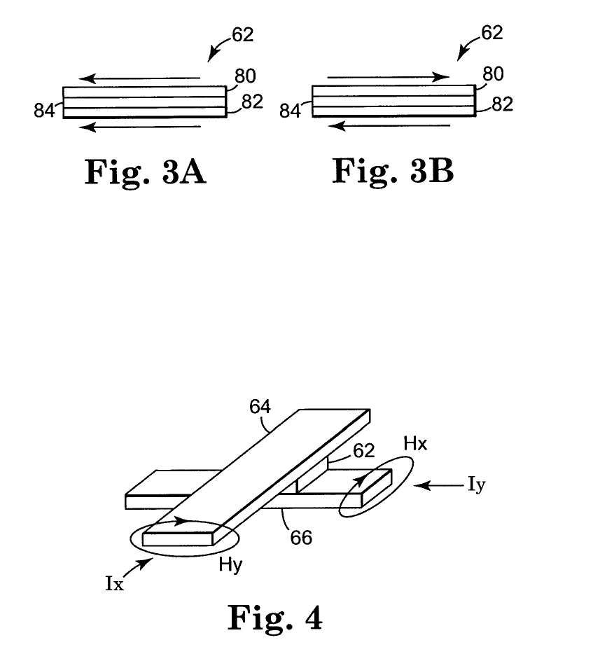

In the exemplary embodiment, magnetic memory 18 includes a row decoder 68, steering circuits 70 and a control circuit 72. Decoder 68 and steering circuits 70 select word lines 64 and bit lines 66 during read and write operations. During write operations, control circuit 72 controls a write circuit which sets the orientation of the magnetization of selected memory cells 62 (see also, FIGS. 3A, 3B and 4). The write circuit is not shown in order to simplify the explanation of the invention.

Sense amplifiers 74 sense the resistance of selected memory cells 62 during read operations. A memory cell 62 is selected by supplying a row address Ax to the decode circuit 68 and a column address Ay to steering circuits 70. In response to the row address Ax, the decode circuit 68 couples one end of a selected word line 64 to ground. In response to the column address Ay, a steering circuit 70 couples a bit line 66 to a sense amplifier 74. A selected memory cell 62 lies at the cross point of the selected word and bit lines 64 and 66.

In the exemplary embodiment, each steering circuit 70 includes a set of switches that connect each bit line 66 to either a constant voltage source or to a sense amplifier 74. Each steering circuit 70 further includes a column decoder. The column decoder selects only one switch for connecting the selected bit line 66 to the sense amplifier 74. All other unselected bit lines 66 are typically connected to a constant voltage source.

FIGS. 3A and 3B are diagrams illustrating parallel and anti-parallel magnetization of a magnetic memory cell. In one embodiment, magnetic memory cell 62 is a spin dependent tunneling device. Magnetic memory cell 62 includes a magnetic layer referred to as data storage layer 80, a magnetic layer referred to as reference layer 82, and a tunnel barrier 84 disposed between data storage layer 80 and reference layer 82. Data storage layer 80 is referred to as a free layer because it has a magnetization orientation that is not pinned and which can be oriented in either of two directions along an easy axis, which lies in a plane. Reference layer 82 is referred to as a pinned layer because it has a magnetization that is oriented in a plane but is fixed so as not to rotate in the presence of an applied magnetic field within a range of interest. The magnetization orientation assumes one of two stable orientations at any given time, which are the parallel and anti-parallel orientations.

FIG. 3A illustrates by arrows the parallel orientation when the magnetization of the free and pinned layers 80 and 82 are in the same direction along the easy axis. With parallel orientation, the orientation of magnetization in the data storage layer 80 is substantially parallel to the magnetization in the reference layer 82 along the easy axis, and magnetic memory cell 62 is in a low resistance state which can be represented by the value R. FIG. 3B illustrates by arrows the anti-parallel orientation when the magnetization of the free and pinned layers 80 and 82 are in opposite directions. With anti-parallel orientation, the orientation of magnetization in the data storage layer 80 is substantially anti-parallel to the magnetization in the reference layer 82 along the easy axis, and magnetic memory cell 62 is in a high resistance state which can be represented by the value R+ΔR. The insulating tunnel barrier 84 allows quantum mechanical tunneling to occur between the free and pinned layers 80 and 82. Because the tunneling is electron spin dependent, the resistance of magnetic memory cell 62 is a function of the relative orientations of the magnetization of the free and pinned layers 80 and 82.

Data is stored in magnetic memory cell 62 by orienting the magnetization along the easy axis of free layer 80. In one embodiment, a logic value of “0” is stored in magnetic memory cell 62 by orienting the magnetization of free layer 80 such that the magnetization orientation is parallel, and a logic value of “1” is stored in magnetic memory cell 62 by orienting the magnetization of free layer 80 such that the magnetization orientation is anti-parallel. In another embodiment, a logic value of “1” is stored in magnetic memory cell 62 by orienting the magnetization of free layer 80 such that the magnetization orientation is parallel, and a logic value of “0” is stored in magnetic memory cell 62 by orienting the magnetization of free layer 80 such that the magnetization orientation is anti-parallel.

FIG. 4 is a diagram illustrating a magnetic memory cell 62 that has been selected. In one embodiment, the magnetization in free layer 80 of selected magnetic memory cell 62 is oriented by supplying the currents Ix and Iy to conductors 64 and 66, which cross the selected magnetic memory cell 62. Supplying the current Ix to word line 64 causes a magnetic field Hy to form around conductor 64. Supplying the current Iy to bit line 66 causes a magnetic field Hx to form around bit line 66. When sufficiently large currents Ix and Iy are passed through word line 64 and bit line 66, the magnetic fields Hx and Hy in the vicinity of free layer 80 cause the magnetization of free layer 80 to rotate from the parallel orientation to the anti-parallel orientation, or to rotate from the anti-parallel orientation to the parallel orientation.

In one embodiment, a magnetic memory cell 62 is read by applying sense currents to word line 64 and bit line 66. Magnetic memory cell 62 will have either a resistance of R or a resistance of R+ΔR, depending on whether the orientation of magnetization of the free and pinned layers 80 and 82 are parallel or anti-parallel, as illustrated in FIGS. 3A and 3B.

FIG. 5 illustrates at 70 a side cross-sectional view illustrating exemplary embodiments of an ARS memory 218 and an ARS memory 246 used in information storage device 14. ARS memory 218/246 includes a number of electron emitters, such as electron emitters 92 and 96, storage medium 98 including a number of storage areas, such as storage area 100, and micromover 102. Micromover 102 scans storage medium 98 with respect to the electron emitters or vice versa. Each storage area is responsible for storing one or more bits of information.

In one embodiment, the electron emitters are point emitters having very sharp points. Alternatively, other electron emitters having any suitable shape may be used (e.g., flat or planar electron emitters). Each point emitter can have a radius of curvature in the range of approximately one nanometer to hundreds of nanometers. During operation, a pre-selected potential difference is applied between an electron emitter and its corresponding gate, such as between electron emitter 92 and gate 94 surrounding it. Due to the sharp point of the emitter, an electron beam current is extracted from the emitter towards the storage area. Depending on the distance between the emitters and the storage medium 98, the type of emitters, and the spot size (bit size) required, electron optics may be utilized to focus the electron beams. A voltage may also be applied to the storage medium 98 to accelerate the emitted electrons and to aid in focusing the emitted electrons.

In one embodiment, casing 112 maintains storage medium 98 in a partial vacuum, such as at least 10⁻⁵ torr. It is known in the art to fabricate such types of microfabricated electron emitters in vacuum cavities using semiconductor processing techniques. See, for example, “Silicon Field Emission Transistors and Diodes,” by Jones, published in IEEE Transactions on Components, Hybrids and Manufacturing Technology, 15, page 1051, 1992.

In the embodiment illustrated in FIG. 5, each electron emitter has a corresponding storage area. In another embodiment, each electron emitter is responsible for a number of storage areas. As micromover 102 scans storage medium 98 to different locations, each emitter is positioned above different storage areas. With micromover 102, an array of electron emitters can scan over storage medium 98.

In various embodiments, the electron emitters read and write information on the storage areas by means of the electron beams they produce. Thus, electron emitters suitable for use in ARS memory 218/246 are the type that can produce electron beams that are narrow enough to achieve the desired bit density on the storage medium and which can provide the different power densities of the beams needed for reading from and writing to the medium. A variety of approaches are known in the art that are suitable to make such electron emitters. For example, one method is disclosed in “Physical Properties of Thin-Film Field Emission Cathodes with Molybdenum Cones,” by Spindt et al, published in the Journal of Applied Physics, Vol. 47, No. 12, December 1976. Another method is disclosed in “Fabrication and Characteristics of Si Field Emitter Arrays,” by Betsui, published in Tech. Digest 4^{th} Int. Vacuum Microelectronics Conf., Nagahama, Japan, page 26, 1991.

In one embodiment, there can be a two-dimensional array of emitters, such as 100 by 100 emitters, with an emitter pitch of 5 to 50 micrometers in both the X and the Y directions. Each emitter may access tens of thousands to hundreds of millions of storage areas. For example, the emitters scan over the storage areas with a periodicity of about 1 to 100 nanometers between any two storage areas. Also, the emitters may be addressed simultaneously or sequentially in a multiplexed manner. Such a parallel accessing scheme significantly increases the data rate of the storage device.

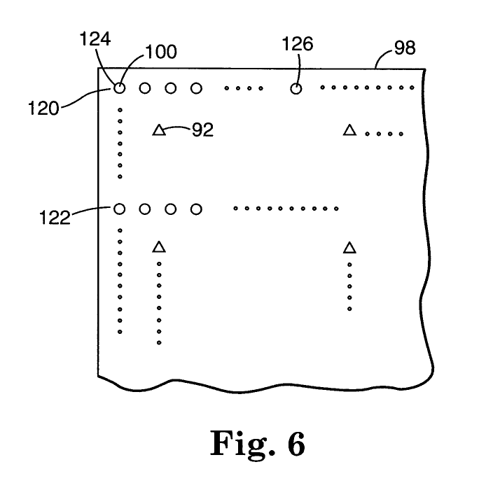

FIG. 6 illustrates a top view of storage medium 98 which includes a two-dimensional array of storage areas and a two-dimensional array of emitters. Addressing the storage areas requires external circuits. One embodiment to reduce the number of external circuits is to separate the storage medium into rows, such as rows 120 and 122, where each row contains a number of storage areas. Each emitter is responsible for a number of rows. However, in this embodiment, each emitter is not responsible for the entire length of the rows. For example, emitter 92 is responsible for the storage areas within rows 120 through 122, and within columns 124 through 126. All rows of storage areas accessed by one emitter are connected to one external circuit. To address a storage area, the emitter responsible for the particular storage area is activated and moved by micromover 102 (illustrated in FIG. 5) to the storage area. The external circuit connected to the rows of storage areas within which the particular storage area lies is activated.

In various embodiments, micromover 102 can also be made in a variety of ways, as long as it has sufficient range and resolution to position the electron emitters over the storage areas. In one embodiment, micromover 102 is fabricated by standard semiconductor microfabrication processes and scans storage medium 98 in the X and Y directions with respect to casing 112.

FIG. 7 illustrates a top view of cross section 7-7 in FIG. 5. FIG. 5 illustrates storage medium 98 being held by two sets of thin-walled microfabricated beams. The faces of the first set of thin-walled beams are in the Y-Z plane as illustrated at 104 and 106. Thin-walled beams 104 and 106 may be flexed in the X direction allowing storage medium 98 to move in the X direction with respect to casing 112. The faces of the second set of thin-walled beams are in the X-Z plane as illustrated at 108 and 110. Thin-walled beams 108 and 110 allow storage medium 98 to move in the Y direction with respect to casing 112. Storage medium 98 is held by the first set of beams, which are connected to frame 114. Frame 114 is held by the second set of beams, which are connected to casing 112. The electron emitters scan over storage medium 98, or storage medium 98 scans over the electron emitters in the X-Y directions by electrostatic, electromagnetic, piezoelectric, or other means known in the art. In this example, micromover 102 moves storage medium 98 relative to the electron emitters. A general discussion of suitable microfabricated micromovers can be found, for example, in “Novel Polysilicon Comb Actuators for XY-Stages,” published in the Proceeding of MicroElectro Mechanical Systems 1992, written by Jaecklin et al.; and in “Silicon Micromechanics: Sensors and Actuators on a Chip”, by Howe et al., published in IEEE Spectrum, page 29, in July 1990.

In other embodiments, the electron beam currents are rastered over the surface of storage medium 98 by either electrostatically or electromagnetically deflecting them, such as by electrostatic deflectors or electrodes 116 (illustrated in FIG. 5) which are positioned adjacent to emitter 96. Many different approaches to deflecting electron beams are known in the art and can be found in literature on Scanning Electron Microscopy.

In one embodiment, writing is accomplished by temporarily increasing the power density of the electron beam current to modify the surface state of the storage area. Reading is accomplished by observing the effect of the storage area on the electron beam, or the effect of the electron beam on the storage area. In one embodiment, a storage area that has been modified can represent a logic value of “1”, and a storage area that has not been modified can represent a logic value of “0”. In one embodiment, a storage area that has been modified can represent a logic value of “0”, and a storage area that has not been modified can represent a logic value of “1”. In other embodiments, the storage area can be modified to different degrees to represent more than two bits. In other embodiments, the modifications can be permanent, or can be reversible. The permanently modified storage medium is suitable for write-once-read-many memory (WORM) applications.

In one embodiment, the basic approach is to alter the structure of the storage area in such a way as to vary its secondary electron emission coefficient (SEEC), its back-scattered electron coefficient (BEC), or the collection efficiency for secondary or back-scattered electrons emanating from the storage area. The SEEC is defined as the number of secondary electrons generated from the medium for each electron incident onto the surface of the medium. The BEC is defined as the fraction of the incident electrons that are scattered back from the medium. The collection efficiency for secondary/back-scattered electrons is the fraction of the secondary/back-scattered electrons that are collected by an electron collector and typically registered in the form of a current.

In various embodiments, reading is accomplished by collecting the secondary and/or back-scattered electrons when an electron beam with a lower power density is applied to storage medium 98. During reading, the power density of the electron beam should be kept low enough so that no further writing occurs.

One embodiment of storage medium 98 includes a material whose structural state can be changed from crystalline to amorphous by electron beams. The amorphous state has a different SEEC and BEC than the crystalline state, which leads to a different number of secondary and back-scattered electrons emitted from the storage area. By measuring the number of secondary and back-scattered electrons, the state of the storage area can be determined. To change the storage area from the amorphous to crystalline state, the beam power density is increased and then slowly decreased. This heats up the amorphous storage area material and then slowly cools it so that the area has time to anneal into the crystalline state. To change from the crystalline to the amorphous state, the beam power density is increased to a high level and then rapidly decreased. To read from the storage medium, a lower-energy beam strikes the storage area. In various embodiments, materials such as germanium telluride (GeTe) or ternary alloys based on GeTe can be used. Similar methods to modify states using laser beams as the heating source have been described in “Laser-induced Crystallization of Amorphous GeTe: A Time-Resolved Study,” by Huber and Marinero, published in Physics Review B 36, page 1595, in 1987, and will not be further described here.

In various embodiments, there are many approaches to induce a state change in storage medium 98. In one embodiment, a change in the topography of the medium, such as a hole or bump, will modify the SEEC and BEC of the storage medium. This modification occurs because the coefficients typically depend on the incident angle of the electron beam onto the storage area. In various embodiments, changes in material properties, band structure, and crystallography may also affect the coefficients. Because the BEC depends on an atomic number, Z, in various embodiments the storage medium has a layer of low Z material on top of a layer of high Z material or vice versa, with writing accomplished through ablating a portion of the top layer by an electron beam.

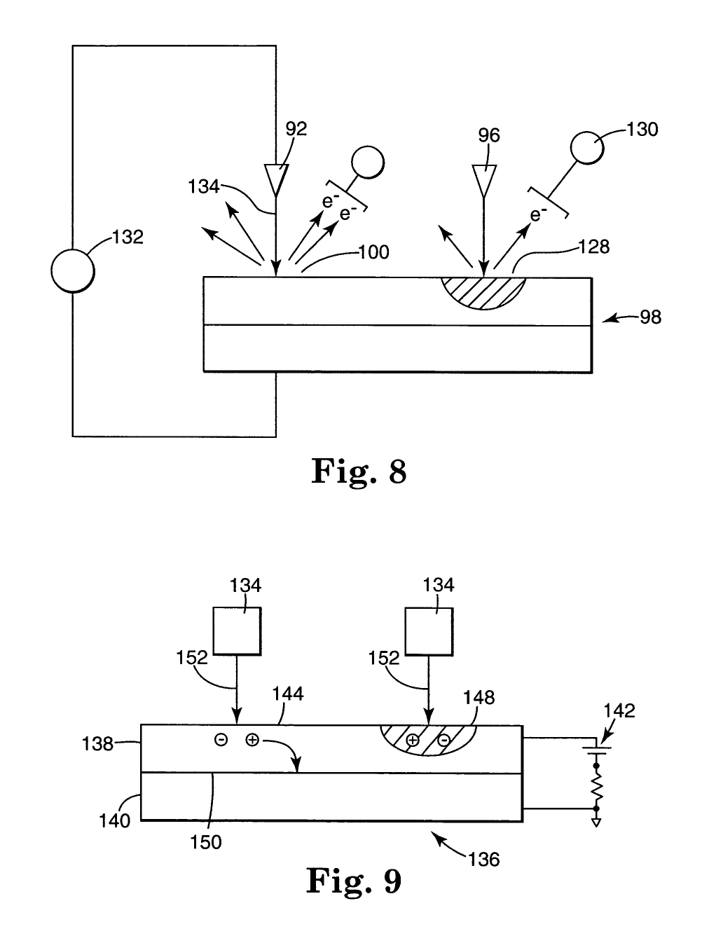

FIG. 8 shows schematically the electron emitters reading from storage medium 98. In the embodiment illustrated in FIG. 8, the state of storage area 128 has been altered, while the state of storage area 100 has not been altered. When electrons bombard a storage area, both secondary electrons and back-scattered electrons will be collected by the electron collectors, such as electron collector 130. An area that has been modified will produce a different number of secondary electrons and back-scattered electrons, as compared to an area that has not been modified. The difference may be more or may be less depending on the type of material and the type of modification. By monitoring the magnitude of the signal collected by electron collectors 130, the state of the bit stored in the storage area can be identified.

FIG. 9 illustrates an embodiment wherein a diode structure is used to determine the state of the storage areas. According to this embodiment, the storage medium 136 is configured as a diode which can, for example, comprise a p-n junction, a schottky barrier, or any other suitable type of electronic valve. FIG. 9 illustrates an example configuration of such a storage medium 136. In other embodiments, alternative diode arrangements (such as those illustrated in U.S. Pat. No. 5,557,596) can be used. As indicated in this figure, the storage medium 136 is arranged as a diode having two layers 138 and 140. By way of example, one of the layers is p type and the other is n type. The storage medium 136 is connected to an external circuit 142 that reverse-biases the storage medium. With this arrangement, bits are stored by locally modifying the storage medium 136 in such a way that collection efficiency for minority carriers generated by a modified region 148 is different from that of an unmodified region 144. The collection efficiency for minority carriers can be defined as the fraction of minority carriers generated by the instant electrons that are swept across a diode junction 150 of the storage medium 136 when the medium is biased by the external circuit 142 to cause a current to flow through the external circuit.

In use, the electron emitters 134 emit narrow beams 152 of electrons onto the surface of the storage medium 136 that excite electron-hole pairs near the surface of the medium. Because the medium 136 is reverse-biased by the external circuit 142, the minority carriers that are generated by the incident electrons are swept toward the diode junction 150. Minority carriers that do not recombine with majority carriers before reaching the junction 150 are swept across the junction, causing a current flow in the external circuit 142.

As described above, writing is accomplished by sufficiently increasing the power density of the electron beams to locally alter the physical properties of the storage medium 136. When the medium 136 is configured as illustrated in FIG. 9, this alteration affects the number of minority carriers swept across the junction 150 when the same area is radiated with a lower power density read electron beam. For instance, the recombination rate in a written (i.e., modified) area 148 could be increased relative to an unwritten (i.e., unmodified) area 144 so that the minority carriers generated in the written area have an increased probability of recombining with majority carriers before they have a chance to reach and cross junction 150. Hence, a smaller current flows in external circuit 142 when the read electron beam is incident upon the written area 148 than when it is incident upon an unwritten area 144. Conversely, it is also possible to start with a diode structure having a high recombination rate and then writing the bits by locally reducing the recombination rate. In either case, the magnitude of the current resulting from the minority carriers depends upon the state of the particular storage area.

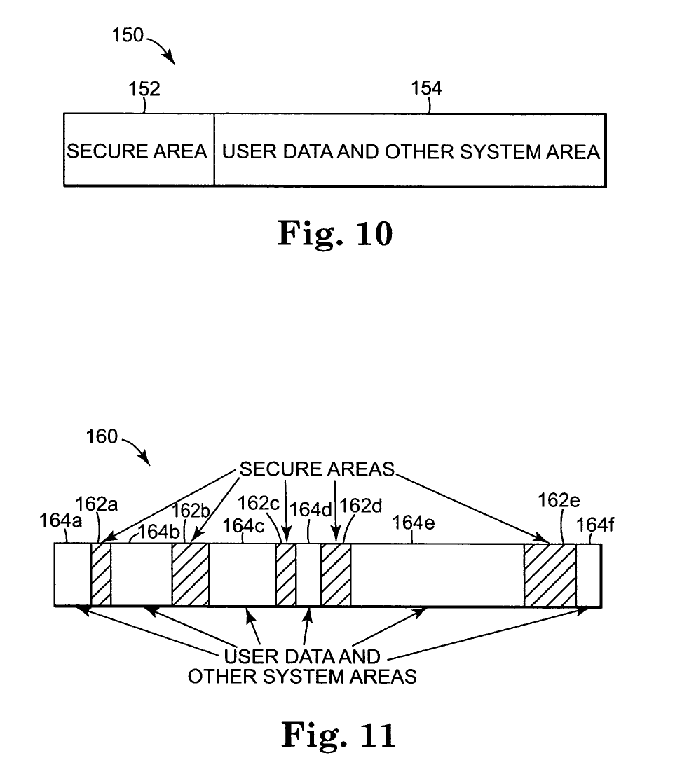

FIG. 10 is a diagram illustrating a first exemplary embodiment of memory allocation. The first exemplary embodiment is illustrated at 150. Memory storage device 18 is partitioned into a first address area illustrated at 152 and a second address area illustrated at 154. The first area 152 is a secure area and the second area 154 is allocated for user data and other system functions. In one embodiment, the first area 152 is accessible by the controller processor 40 and the second area 154 is accessible by the host 12. In one embodiment, the encrypted encryption keys and encrypted data are stored in the first area 152. In one embodiment, the encrypted encryption keys are stored in the first area 152 and the encrypted data and data that is not encrypted is stored in the second area 154. In one embodiment, the encrypted encryption keys are stored in the first area 152 and the encrypted data is stored in the first area 152 and the second area 154. In the exemplary embodiment, the first area 152 corresponds to a block of memory addresses within memory storage device 18 which are allocated for the first area 152. The second area 154 corresponds to a block of memory addresses within memory storage device 18 which are allocated for the second area 154.

FIG. 11 is a diagram illustrating a second exemplary embodiment of memory allocation. The second exemplary embodiment is illustrated at 160. The first address areas or secure areas are illustrated at 162 and the second address areas for user data and other system functions are illustrated at 164. In one embodiment, the first areas are accessible by the controller processor 40 and the second areas are accessible by the host 12. In one embodiment, the encrypted encryption keys and encrypted data are stored in the first areas 162. In one embodiment, the encrypted encryption keys are stored in the first areas 162 and the encrypted data is stored in the second areas 164; In one embodiment, the encrypted encryption keys are stored in the first areas 162 and the encrypted data is stored in the first areas 162 and the second areas 164.

In one embodiment, the first areas illustrated at 162a, 162b, 162c, 162d and 162e are blocks of memory addresses which are located at predetermined address locations within memory storage device 18. In this embodiment, there can be any suitable number of predetermined address locations, and the memory address blocks at each location 162 can be any suitable size. The second areas illustrated at 164a, 164b, 164c, 164d, 164e and 164f are blocks of memory addresses which are located between or next to first areas 162.

In one embodiment, the first areas at 162 are located at one or more random address locations within memory storage device 18. In this embodiment, the address locations at 162a, 162b, 162c, 162d, and 162e are chosen randomly. In this embodiment, there can be any suitable number of random address locations, and the memory address blocks at each location 162 can be any suitable size. The second areas illustrated at 164a, 164b, 164c, 164d, 164e and 164f are blocks of memory addresses which are located between or next to the first areas at 162.

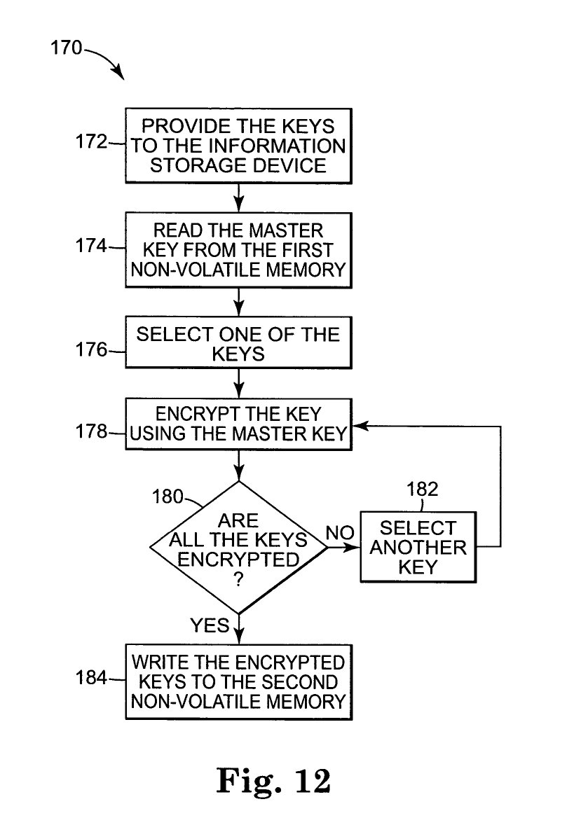

FIG. 12 is a flowchart illustrating an exemplary embodiment of a method of encrypting encryption keys using a master encryption key in an information storage device 14. The flowchart is illustrated at 170. The method at 172 provides the encryption keys to the information storage device 14. In one embodiment, the encryption keys are provided to the information storage device 14 via diagnostic port 50. In other embodiments, the encryption keys are provided to the information storage device 14 from the memory storage device 18, the host 12 or from other suitable sources. In the exemplary embodiment, the master key memory 46 is a first non-volatile memory and the memory storage device 18 is a second non-volatile memory. The method at 174 reads a master encryption key from the first non-volatile memory. The method at 176 selects one of the encryption keys to be encrypted. The method at 178 encrypts the encryption key using the master encryption key. The method at 180 determines if all of the encryption keys have been encrypted. If all of the encryption keys have not been encrypted, the method at 182 selects another encryption key to be encrypted and goes back to the method at 178. If the method at 180 determines that all of the encryption keys have been encrypted, the method at 184 writes the encrypted keys to the memory second non-volatile memory.

In various embodiments, the method at 170 provides a means for encrypting the encryption keys using a master encryption key and storing the encrypted encryption keys in memory storage device 18. In one embodiment, the method at 170 is performed when the information storage device 14 is manufactured. In one embodiment, the encrypted encryption keys can be written to memory storage device 18 the first time that memory storage device 18 is written. In other embodiments, the method at 170 can be preformed at other suitable times. In other embodiments, the keys are encrypted simultaneously with two or more of the keys being encrypted at a time.

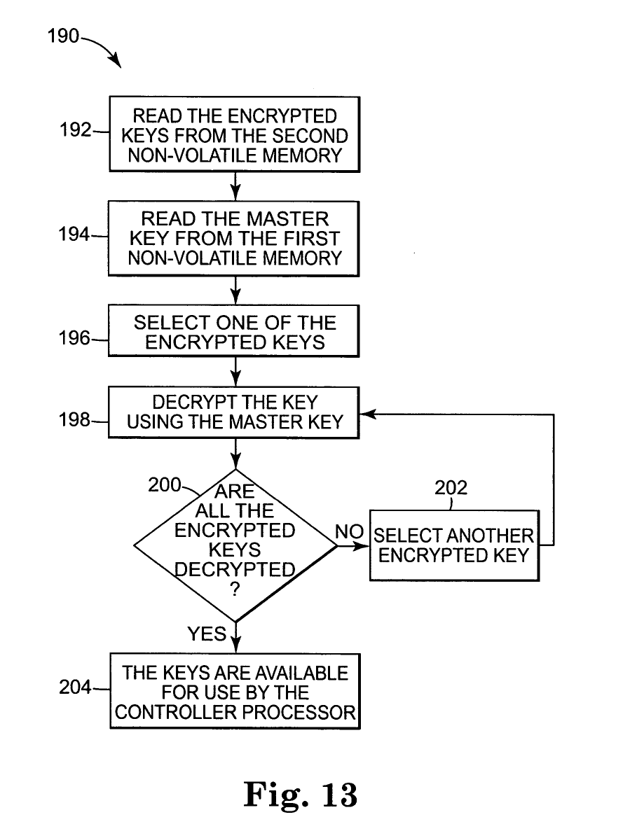

FIG. 13 is a flowchart illustrating an exemplary embodiment of a method of decrypting encryption keys in an information storage device 14. The flowchart is illustrated at 190. The method at 192 reads the encryption keys from memory storage device 18. In the exemplary embodiment, memory storage device 18 is a second non-volatile memory. The method at 194 reads a master encryption key from master key memory 46. In the exemplary embodiment, master key memory 46 is a first non-volatile memory. The method at 196 selects one of the encryption keys to be decrypted. The method at 198 decrypts the encryption key using the master key. The method at 200 determines if all of the encrypted encryption keys have been decrypted. If all of the encrypted encryption keys have not been decrypted, the method at 202 selects another encrypted encryption key to be decrypted and goes back to the method at 198. If the method at 200 determines that all of the encrypted encryption keys have been decrypted, the keys are now available for use by controller processor 40.

In one embodiment, the decrypted encryption keys are used by controller processor 40 to decrypt the encrypted data. In this embodiment, the encrypted data is read from the second non-volatile memory and decrypted using the keys. In one embodiment, the decrypted encryption keys are used by controller processor 40 to encrypt the data and write the encrypted data to the second non-volatile memory. In various embodiments, the decrypted encryption keys are used for secure transactions or authentication between information storage device 14 and host 12.

In various embodiments, the method at 190 provides a means for decrypting the encryption keys and for making the decrypted encryption keys available to encrypt or decrypt data. In one embodiment, the method at 190 is performed each time the information storage device 14 is powered up or turned on. In one embodiment, the encryption keys are decrypted simultaneously with two or more of the encryption keys being decrypted at a time. In other embodiments, the method at 190 can be preformed at other suitable times. In one embodiment, once the encrypted encryption keys are decrypted, encrypted data can be read from the second non-volatile memory and decrypted using the encryption keys. In one embodiment, once the encrypted encryption keys are decrypted, data can be encrypted using the encryption keys and written to the second non-volatile memory.

1. A removable information storage device suitable for use with a host, comprising:
a non-volatile memory configured to store a master encryption key; and
a non-volatile magnetic memory configured to store encryption keys which have been encrypted using the master encryption key and to store data which has been encrypted using the encryption keys.

2. The information storage device of claim 1, further comprising an encryption and decryption engine configured to encrypt and decrypt the encryption keys using the master encryption key and to encrypt and decrypt the data using one or more of the encryption keys.

3. The information storage device of claim 1, wherein the first non-volatile memory is a magnetic memory.

4. The information storage device of claim 1, wherein the first non-volatile memory is a read-only memory which includes fuse elements.

5. The information storage device of claim 1, wherein the first non-volatile memory is a nitrided read-only memory.

6. The information storage device of claim 1, wherein the first non-volatile memory is an erasable programmable read-only memory.

7. The information storage device of claim 1, wherein the first non-volatile memory is an electronically erasable programmable read-only memory.

8. The information storage device of claim 1, wherein the first non-volatile memory is a flash erasable programmable read-only memory.

9. The information storage device of claim 1, wherein the first non-volatile memory is a one time programmable read-only memory.

10. The information storage device of claim 1, wherein the non-volatile magnetic memory is a magnetic random access memory.

11. The information storage device of claim 1, wherein the second non-volatile memory is partitioned into first and second areas, and wherein the encrypted encryption keys are stored in the first areas and the encrypted data is stored in the second areas.

12. The information storage device of claim 1, wherein the second non-volatile memory is partitioned into first and second areas, and wherein the encrypted encryption keys and the encrypted data are stored in the first areas.

13. The information storage device of claim 1, wherein the second non-volatile memory is partitioned into first and second areas, and wherein the encrypted encryption keys are stored in the first areas and the encrypted data is stored in the first and second areas.

14. The information storage device of claim 13, wherein the first areas are located at one or more predetermined address locations within the second non-volatile memory.

15. The information storage device of claim 13, wherein the first areas are located at one or more random address locations within the second non-volatile memory.

16. A portable memory card, comprising:
a non-volatile memory storage device configured to store one or more encrypted encryption keys and encrypted data; and
a card controller system coupled to the memory storage device configured to store and retrieve the encrypted encryption keys and the encrypted data from the memory storage device, wherein the encryption keys are encrypted and decrypted using a master encryption key and the data is encrypted and decrypted using the encryption keys.

17. The portable memory card of claim 16, wherein the non-volatile memory is a magnetic memory.

18. The portable memory card of claim 16, wherein the non-volatile memory is an atomic resolution storage memory.

19. The portable memory card of claim 16, wherein the card controller system includes a non-volatile master key memory configured to store the master encryption key.

20. The portable memory card of claim 16, wherein the card controller system includes an encryption and decryption engine configured to store one or more encryption algorithms and use the encryption algorithms to encrypt and decrypt the encryption keys using the master encryption key and encrypt and decrypt the data using the encryption keys.

21. The portable memory card of claim 16, wherein the memory storage device is partitioned into first and second areas, and wherein the encrypted encryption keys are stored in the first areas and the encrypted data is stored in the second areas.

22. The portable memory card of claim 16, wherein the memory storage device is partitioned into first and second areas, and wherein the encrypted encryption keys and the encrypted data are stored in the first areas.

23. The portable memory card of claim 16, wherein the memory storage device is partitioned into first and second areas, and wherein the encrypted encryption keys are stored in the first areas and the encrypted data is stored in the first and second areas.

24. A memory card, comprising:
a non-volatile master key memory configured to store a master encryption key;
an encryption and decryption engine configured to implement one or more symmetrical encryption key algorithms based on the master encryption key and encryption keys;
a memory storage device comprising an atomic resolution storage device including a field emitter, a media and a micromover, the atomic resolution storage device configured to store the encryption keys after the encryption keys are encrypted using the master encryption key and to store data after the data is encrypted using the encryption keys;
a host interface configured to provide a communication interface to a host;
a memory interface configured to provide a communication interface to the memory storage device;
a data path manager configured to manage communication of the data and the encrypted data between the host and the memory storage device; and
a controller processor configured to control the encryption and decryption of the encryption keys using the master encryption key and the encryption and decryption of the data using the encryption keys.

25. An information storage device, comprising:
a non-volatile memory storage device configured to store one or more encrypted encryption keys and encrypted data; and
controller means configured to store and retrieve the encrypted encryption keys and the encrypted data from the memory storage device and to encrypt and decrypt the encryption keys using a master encryption key and to encrypt and decrypt the data using the encryption keys.

26. The information storage device of claim 25, wherein the controller means includes a non-volatile master key memory configured to store the master encryption key.

27. A method of encrypting encryption keys using a master encryption key in an information storage device, comprising:
providing the encryption keys to the information storage device;
reading a master encryption key from a non-volatile memory;
encrypting each one of the encryption keys using the master encryption key; and
writing the encrypted encryption keys to a random access memory.

28. A method of decrypting encryption keys in an information storage device, comprising:
reading the encrypted encryption keys from the magnetic random access memory;
reading a master encryption key from a first non-volatile memory; and
decrypting each one of the encryption keys using the master encryption key.

29. The method of claim 28, comprising:
reading encrypted data from the magnetic random access memory; and
decrypting the encrypted data using the encryption keys.

30. The method of claim 28, comprising;
encrypting the data using the encryption keys; and
writing the encrypted data to the magnetic random access memory.
